(19) United States
(12) Patent Application Publication
(10) Pub. No.: US 2026/0094807 A1
(43) Pub. Date: Apr. 2, 2026

(54) CATHODE FOR SECONDARY BATTERY AND LITHIUM SECONDARY BATTERY INCLUDING THE SAME

(71) Applicant: SK ON CO., LTD., Seoul (KR)

(72) Inventors: Jeong Seok YEON, Daejeon (KR); Jae Ram KIM, Daejeon (KR); Ji Hee BAE, Daejeon (KR); Yeon Hwa SONG, Daejeon (KR); Myung Ro LEE, Daejeon (KR)

(21) Appl. No.: 19/339,304

(22) Filed: Sep. 25, 2025

(30) Foreign Application Priority Data
Oct. 2, 2024 (KR) 10-2024-0133882

(51) Int. Cl. H01M 4/131; H01M 4/02; H01M 4/36; H01M 4/525; H01M 4/58; H01M 4/62; H01M 10/0525

(52) U.S. Cl. CPC H01M 4/131; H01M 4/366; H01M 4/525; H01M 4/5825; H01M 4/625; H01M 10/0525; H01M 2004/021; H01M 2004/028

(57) ABSTRACT

A cathode for a secondary battery according to the present disclosure includes: a cathode current collector, and a first cathode active material layer and a second cathode active material layer sequentially stacked on at least one surface of the cathode current collector. The first cathode active material layer includes a lithium transition metal oxide. The second cathode active material layer includes a lithium metal phosphate, a particulate conductive material and a fibrous conductive material. The ratio of the content of the fibrous conductive material to that of the particulate conductive material, based on the total weight of the second cathode active material layer, is 2 to 7.

### CROSS-REFERENCE TO RELATED APPLICATION

This application claims priority under 35 U.S.C. § 119 to Korean Patent Application No. 10-2024-0133882, filed on Oct. 2, 2024, the disclosure of which is incorporated herein by reference in its entirety.

### BACKGROUND

### 1. Field of the Invention

The present disclosure relates to a cathode for a secondary battery and a lithium secondary battery including the same.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric cars.

Examples of the secondary battery may include a lithium secondary battery, a nickel-cadmium battery, and a nickel-hydrogen battery. Among these, lithium secondary batteries are actively being researched and developed due to their high operating voltage, high energy density per unit weight, and advantages in charging speed and weight reduction.

For example, the lithium secondary battery may include: an electrode assembly including a cathode, an anode, and a separation membrane (separator); and an electrolyte in which the electrode assembly is impregnated. The lithium secondary battery may further include, for example, a pouch-type outer case in which the electrode assembly and the electrolyte are accommodated.

It is desirable for a lithium secondary battery to have a high capacity and to maintain operational and storage stability under extremely high or low temperature environments. Therefore, the development of a cathode capable of achieving a high-capacity and high-stability lithium secondary battery is required.

### SUMMARY OF THE INVENTION

An object of the present disclosure is to provide a cathode for a secondary battery with improved electrochemical characteristics.

Another object of the present disclosure is to provide a lithium secondary battery including the cathode.

A cathode for a secondary battery according to the present disclosure includes: a cathode current collector, and a first cathode active material layer and a second cathode active material layer sequentially stacked on at least one surface of the cathode current collector. The first cathode active material layer includes lithium transition metal oxide particles. The second cathode active material layer includes lithium metal phosphate particles, a particulate conductive material and a fibrous conductive material. The ratio of the fibrous conductive material to the particulate conductive material, based on the total weight of the second cathode active material layer, is 2 to 7.

According to some embodiments, the ratio of the fibrous conductive material to the particulate conductive material, based on the total weight of the second cathode active material layer, may be 2.5 to 5.

According to some embodiments, the ratio of the fibrous conductive material to the particulate conductive material, based on the total weight of the second cathode active material layer, may be 2.33 to 5.67.

According to some embodiments, the particulate conductive material may include at least one selected from the group consisting of carbon black, graphite, graphene, tin, tin oxide, titanium oxide, LaSrCoO₃ and LaSrMnO₃.

According to some embodiments, the fibrous conductive material may include at least one selected from the group consisting of carbon nanotubes (CNTs), vapor-grown carbon fibers (VGCFs) and carbon nanofibers (CNFs).

According to some embodiments, the content of the particulate conductive material, based on the total weight of the second cathode active material layer, may be greater than 0 and less than or equal to 0.4% by weight.

According to some embodiments, the content of the particulate conductive material, based on the total weight of the second cathode active material layer, may be 0.15 to 0.3% by weight.

According to some embodiments, the content of the fibrous conductive material, based on the total weight of the second cathode active material layer, may be greater than 0 and less than or equal to 1% by weight.

According to some embodiments, the content of the fibrous conductive material, based on the total weight of the second cathode active material layer, may be 0.7 to 0.85% by weight.

According to some embodiments, the lithium transition metal oxide particles may include a crystal structure represented by Formula 1 below.

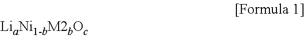

In Formula 1, 0<a≤1.2, 0<b<1, 2≤c≤2.02, and M2 may include at least one selected from the group consisting of Co, Mn, Na, Mg, Ca, Ti, V, Cr, Cu, Zn, Ge, Sr, Ag, Ba, Zr, Nb, Mo, Al, Ga and B.

According to some embodiments, the lithium transition metal oxide particles may have a median particle diameter (D50) of 2 μm to 20 μm.

According to some embodiments, the lithium metal phosphate particles may include manganese.

According to some embodiments, the lithium metal phosphate particles may have a crystal structure represented by Formula 2 below.

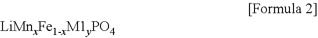

In Formula 2, 0<x<1, 0≤y≤0.1, and M1 may include at least one selected from the group consisting of Ni, Co, Na, Mg, Ca, Ti, V, Cr, Cu, Zn, Ge, Sr, Ag, Ba, Zr, Nb, Mo, Al, Ga and B.

According to some embodiments, x may be in the range of 0.5≤x≤0.8.

According to some embodiments, the lithium metal phosphate particles may have a median particle diameter (D50) of 0.1 μm to 1.5 μm.

According to some embodiments, the ratio of the thickness of the second cathode active material layer to the thickness of the first cathode active material layer may be 1.5 to 4.

According to some embodiments, the second cathode active material layer may have an electrode density of 2.0 g/cc to 2.5 g/cc.

A lithium secondary battery according to the present disclosure includes: an anode; and the cathode for a secondary battery disposed to face the anode.

The cathode for a secondary battery according to some embodiments of the present disclosure may have high capacity and high energy density, and low electrode resistance.

The cathode for a secondary battery according to some embodiments of the present disclosure may have improved fast charge and discharge performance and thermal stability. Thus, degradation in battery performance may be prevented even when exposed to high-temperature environments, the occurrence of explosions or fires may be suppressed, and battery capacity does not significantly decrease even during repeated fast charge and discharge cycles.

The lithium secondary battery according to some embodiments of the present disclosure includes the cathode and may have high capacity, improved fast charge and discharge performance, and enhanced high-temperature cycle life characteristics as well as high-temperature storage characteristics.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view illustrating a cathode for a lithium secondary battery according to some embodiments;

FIGS. 2 and 3 are schematic plan and cross-sectional views, respectively, illustrating a lithium secondary battery according to some embodiments; and

FIGS. 4 and 5 are scanning electron microscope (SEM) images showing the cross-section of a cathode of Comparative Example 7 at 1,000× and 5,000×, respectively.

### DETAILED DESCRIPTION

The present disclosure provides a cathode for a secondary battery having a multi-layer structure. The present disclosure also provides a lithium secondary battery including the cathode.

Hereinafter, exemplary embodiments of the present disclosure will be described in detail with reference to the accompanying drawings. However, these embodiments are merely illustrative, and the present disclosure is not limited to the specific embodiments described as examples.

The terms “first” and “second” used herein are not intended to limit the number or order of objects modified by “first” and “second,” but rather are used solely to distinguish different modified objects from each other.

The particle size used herein refers to the average diameter of spherical particles and the average major axis length of non-spherical particles. The average particle diameter (average diameter) is the median particle diameter (median diameter) (D50), which is defined as the particle diameter corresponding to the cumulative particle size distribution at 50%, and represents the particle diameter smaller than 50% of the sample.

For example, the median particle diameter (D50) may be measured using a laser diffraction method. Specifically, the median particle diameter (D50) may be calculated by dispersing the target particles in a dispersion medium, introducing the dispersion into a commercially available laser diffraction particle size measuring device (e.g., Microtrac MT 3000), irradiating the dispersion with ultrasonic waves of about 28 kHz at an output of 60 W, and then calculating the median particle diameter (D50) based on the 50% point of the cumulative particle volume-based distribution according to particle size measured by the device.

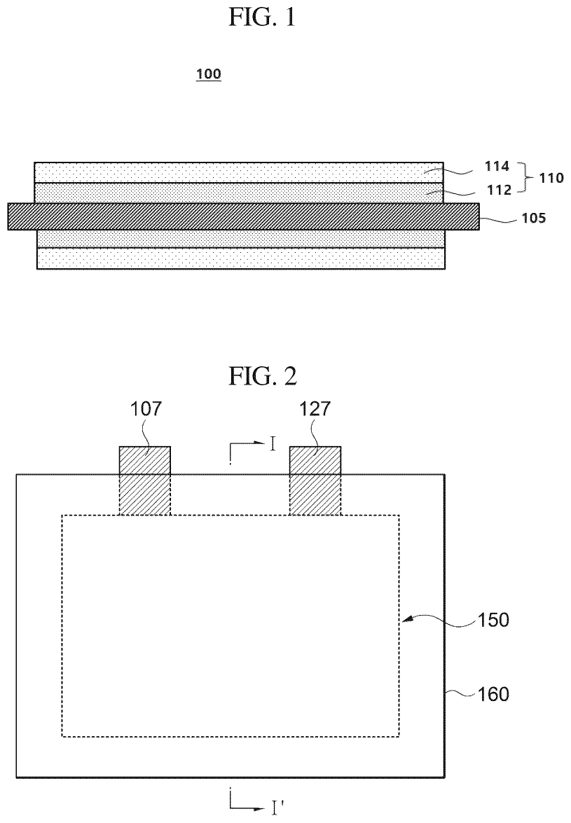

FIG. 1 is a schematic cross-sectional view illustrating a cathode for a lithium secondary battery according to some embodiments.

Referring to FIG. 1, a cathode 100 includes a cathode current collector 105, and a cathode active material layer 110 formed on at least one surface of the cathode current collector 105. The cathode active material layer 110 may be formed on both surfaces (e.g., the upper and lower surfaces) of the cathode current collector 105.

The cathode current collector 105 may include, for example, stainless steel, nickel, aluminum, titanium, copper, or an alloy thereof, and preferably includes aluminum or an aluminum alloy.

According to some embodiments, the cathode active material layer 110 includes a first cathode active material layer 112 and a second cathode active material layer 114. Accordingly, the cathode 100 may have a multi-layer structure (e.g., a double-layer structure) in which a plurality of cathode active material layers are stacked.

As shown in FIG. 1, the first cathode active material layer 112 and the second cathode active material layer 114 are sequentially stacked on a surface of the cathode current collector 105. For example, the first cathode active material layer 112 may be formed on the upper and lower surfaces of the cathode current collector 105, respectively. The second cathode active material layer 114 may be formed on the first cathode active material layer 112.

The first cathode active material layer 112 may be in direct contact with the surface of the cathode current collector. The second cathode active material layer 114 may be in direct contact with the upper surface of the first cathode active material layer 112.

The first cathode active material layer 112 includes lithium transition metal oxide particles. While lithium transition metal oxides may increase the capacity of a battery, their stability may be lower than that of a lithium metal phosphate, as described below.

According to some embodiments, the lithium transition metal oxide particles may include lithium, nickel, oxygen, and elements different from nickel. Among the lithium transition metal oxides, the content of nickel may be the highest based on the total molar amount of elements excluding lithium and oxygen. For example, among the lithium transition metal oxides, the content of nickel may be 30 mol % or more, 40 mol % or more, 50 mol % or more, 60 mol % or more, 70 mol % or more, or 80 mol % or more, based on the total molar amount of elements excluding lithium and oxygen.

According to some embodiments, the lithium transition metal oxide may include nickel, cobalt and manganese.

For example, nickel may be provided as a metal associated with the output and/or capacity of the lithium secondary battery. As the content of nickel increases, the capacity characteristics of the lithium transition metal oxide may improve, but its stability may decrease.

For example, manganese (Mn) may be provided as a metal associated with the mechanical and electrical stability of the lithium secondary battery. For instance, cobalt (Co) may be provided as a metal associated with the conductivity or resistance of the lithium secondary battery.

According to some embodiments, the lithium transition metal oxide particles may include a crystal structure represented by Formula 1 below.

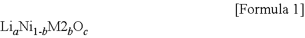

In Formula 1, a, b and c may satisfy (<a≤1.2, 0<b<1, and 25c≤2.02, and M2 may include at least one selected from the group consisting of Co, Mn, Na, Mg, Ca, Ti, V, Cr, Cu, Zn, Ge, Sr, Ag, Ba, Zr, Nb, Mo, Al, Ga and B.

In Formula 1, b may be in the range of 0<b≤0.9. In some embodiments, in Formula 1, b may be in the range of 0<b≤<0.8 or 0<b≤0.5.

According to some embodiments, the lithium transition metal oxide particles may have a crystal structure represented by Formula 1-1 below.

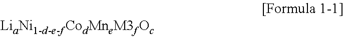

In Formula 1-1, a, c, d, e and f may satisfy 0<a≤1.2, 2≤c≤2.02, 0<d≤0.2, 0<e≤0.4, and 0≤f≤0.2, and M3 may include at least one selected from the group consisting of Na, Mg, Ca, Ti, V, Cr, Cu, Zn, Ge, Sr, Ag, Ba, Zr, Nb, Mo, Al, Ga and B.

In Formula 1-1, d may be in the range of 0.01≤d≤0.15, and e may be in the range of 0.1≤e≤0.35.

In Formula 1-1, d, e and f may be in a range such that 0.3≤1-d-e-f<1 or 0.4≤1-d-e-f≤0.8.

In some embodiments, the concentration ratio (or molar ratio) of nickel, cobalt and manganese in the lithium transition metal oxide particles may be adjusted to about 6:1:3.

According to some embodiments, the lithium transition metal oxide particles may have a median particle diameter (D50) of 2 μm to 20 μm. According to some embodiments, the lithium transition metal oxide particles may have a median particle diameter (D50) of 3 μm to 10 μm.

According to some embodiments, the first cathode active material layer 112 may further include a conductive material and/or a binder.

The conductive material may be included to promote electron transfer between active material particles. For example, the conductive material may include carbon-based conductive materials such as graphite, carbon black, graphene, or carbon nanotubes; metal-based conductive materials such as tin, tin oxide, or titanium oxide; or perovskite materials such as LaSrCoO₃ or LaSrMnO₃. These may be used alone or in combination of two or more thereof.

According to some embodiments, the content of the conductive material, based on the total weight of the first cathode active material layer 112, may be 0.1% by weight (“wt %”) to 5 wt %. According to some embodiments, the content of the conductive material, based on the total weight of the first cathode active material layer 112, may be 0.3 wt % to 2 wt %.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as a binder for forming the cathode. In this case, an amount of binder for forming the first cathode active material layer 112 may be reduced and an amount of cathode active material may be relatively increased, thereby improving the output and capacity of the secondary battery.

According to some embodiments, the content of the binder, based on the total weight of the first cathode active material layer 112, may be 0.5 wt % to 10 wt %. According to some embodiments, the content of the binder, based on the total weight of the first cathode active material layer 112, may be 1 wt % to 5 wt %.

According to some embodiments, the first cathode active material layer 112 may have a thickness of 10 μm to 100 μm. According to some embodiments, the first cathode active material layer 112 may have a thickness of 20 μm to 60 μm.

According to some embodiments, the first cathode active material layer 112 may have an electrode density of 2 g/cc to 4 g/cc. According to some embodiments, the first cathode active material layer 112 may have an electrode density of 2.5 g/cc to 3.6 g/cc.

The electrode density may be calculated by dividing the total weight of the cathode active material layer by the total volume thereof, and may be determined, for example, by punching the electrode to a predetermined size and measuring the mass and volume of the portion excluding the current collector.

The second cathode active material layer 114 includes lithium metal phosphate particles. Lithium metal phosphate may have high stability because it does not undergo side reactions or decomposition at high temperatures, but may have lower capacity characteristics than those of the lithium transition metal oxide.

According to some embodiments, the lithium metal phosphate may include manganese and iron. The ratio of the molar amount of manganese to the total molar amount of iron included in the lithium metal phosphate may be 0.2 to 9, 0.5 to 8, 1 to 5, or 1 to 3.

According to some embodiments, the lithium metal phosphate particles may include a crystal structure represented by Formula 2 below.

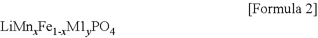

In Formula 2, x and y may satisfy 0<x<1, and 0≤y≤0.1, and M1 may include at least one selected from the group consisting of Ni, Co, Na, Mg, Ca, Ti, V, Cr, Cu, Zn, Ge, Sr, Ag, Ba, Zr, Nb, Mo, Al, Ga and B.

According to some embodiments, in Formula 2, x may be in the range of 0.5≤x≤0.8.

According to some embodiments, the lithium metal phosphate particles may have a median particle diameter (D50) of 0.1 μm to 1.5 μm. In some embodiments, the lithium metal phosphate particles may have a median particle diameter (D50) of 0.3 μm to 1 μm.

According to some embodiments, the lithium metal oxide particles and/or the lithium metal phosphate particles may further include a coating layer on their surfaces. For example, the coating layer may include Al, Ti, Ba, Zr, Si, B, Mg, P, W, or an alloy or oxide thereof. These may be used alone or in combination of two or more thereof. By the coating layer, the active material particles may be passivated, thereby further enhancing the safety against penetration and cycle life of the battery.

In one embodiment, the elements, alloy, or oxide of the above-described coating layer may be inserted into the lithium metal oxide particles and/or the lithium metal phosphate particles as dopants.

The second cathode active material layer 114 includes a particulate conductive material and a fibrous conductive material. The lithium metal phosphate may exhibit a relatively lower electrical conductivity than the lithium transition metal oxide. Furthermore, the lithium metal phosphate may have a relatively smaller particle size than the lithium transition metal oxide.

Therefore, to prevent deterioration in rate characteristics due to a small pore volume within the second cathode active material layer 114, the second cathode active material layer 114 may include different types of conductive materials. This may enhance the electrical conductivity of the active material layer and reduce cell resistance.

The ratio of the content of the fibrous conductive material to that of the particulate conductive material, based on the total weight of the second cathode active material layer 114, may be 2 to 7.

According to some embodiments, the ratio of the content of the fibrous conductive material to that of the particulate conductive material, based on the total weight of the second cathode active material layer, may be 2.5 to 5 or 3 to 4.5. In some embodiments, the ratio of the content of the fibrous conductive material to that of the particulate conductive material, based on the total weight of the second cathode active material layer, may be 2.33 to 5.67. Alternatively, the ratio may be 2 or more, 3 or more, 4 or more, or 5 or more, or 6 or less, 5 or less, 4 or less, or 3 or less.

Within the above range, the electrode density may be improved and the internal resistance of the electrode may be reduced.

If the ratio of the content of the fibrous conductive material to that of the particulate conductive material, based on the total weight of the second cathode active material layer, is less than 2, the internal resistance of the electrode may increase or the electrode density may decrease.

If the ratio of the content of the fibrous conductive material to that of the particulate conductive material, based on the total weight of the second cathode active material layer, is greater than 7, the fibrous conductive material having a relatively larger volume may be excessively included, which may increase the volume of the cathode active material layer and reduce the energy density of the battery.

According to some embodiments, the particulate conductive material may include at least one selected from the group consisting of carbon black, graphite, graphene, tin, tin oxide, titanium oxide, LaSrCoO₃ and LaSrMnO₃. In one embodiment, the particulate conductive material may include carbon black.

The particulate conductive material may be in the form of pseudospherical particles.

According to some embodiments, the fibrous conductive material may include at least one selected from the group consisting of carbon nanotubes (CNTs), vapor-grown carbon fibers (VGCFs) and carbon nanofibers (CNFs). According to an embodiment, the fibrous conductive material may include carbon nanotubes.

The fibrous conductive material may have the largest size in a longitudinal direction and may have, for example, a rod shape or a columnar shape. The ratio of the lengthwise dimension to the widthwise dimension of the fibrous conductive material (lengthwise/widthwise) may be about 3 to 1000.

The carbon nanotubes may include single-walled carbon nanotubes, multi-walled carbon nanotubes and the like. The carbon nanotubes may have a length of about 5 μm to 50 μm.

According to some embodiments, the content of the particulate conductive material, based on the total weight of the second cathode active material layer, may be greater than 0 and less than or equal to 0.4 wt %. In some embodiments, the content may be 0.15 wt % or more, 0.2 wt % or more, 0.25 wt % or more, or 0.3 wt % or more, or 0.3 wt % or less, 0.25 wt % or less, 0.2 wt % or less, or 0.15 wt % or less. According to some embodiments, the content of the particulate conductive material, based on the total weight of the second cathode active material layer, may be 0.01 wt % to 0.4 wt %, 0.05 wt % to 0.4 wt %, 0.1 wt % to 0.3 wt %, or 0.15 wt % to 0.3 wt %.

According to some embodiments, the content of the fibrous conductive material, based on the total weight of the second cathode active material layer, may be greater than 0 and less than or equal to 1 wt %. According to some embodiments, the content may be 0.5 wt % or more, 0.7 wt % or more, 0.8 wt % or more, or 0.85 wt % or more, or 0.85 wt % or less, 0.8 wt % or less, 0.7 wt % or less, or 0.5 wt % or less. According to some embodiments, the content of the fibrous conductive material, based on the total weight of the second cathode active material layer, may be 0.01 wt % to 1 wt %, 0.1 wt % to 0.8 wt %, 0.2 wt % to 0.7 wt %, or 0.7 wt % to 0.85 wt %.

Within the above range, the electrical conductivity of the second cathode active material layer 114 may be increased while preventing a decrease in electrode density.

According to some embodiments, the second cathode active material layer 114 may further include a binder. The binder may be the same as that described with respect to the first cathode active material layer 112.

According to some embodiments, the content of the binder, based on the total weight of the second cathode active material layer 114, may be 0.5 wt % to 10 wt %. In some embodiments, the content of the binder, based on the total weight of the second cathode active material layer 114, may be 1 wt % to 5 wt %.

According to some embodiments, the second cathode active material layer 114 may have a thickness of 30 μm to 200 μm. In some embodiments, the second cathode active material layer 114 may have a thickness of 50 μm to 150 μm.

According to some embodiments, the ratio of the thickness of the second cathode active material layer 114 to that of the first cathode active material layer 112 may be 1.5 to 4. In some embodiments, the ratio of the thickness of the second cathode active material layer 114 to that of the first cathode active material layer 112 may be 2 to 3.

Within the above range, the energy densities of the first cathode active material layer 112 including a high-capacity lithium transition metal oxide and the second cathode active material layer 114 including a high-stability lithium metal phosphate may be at similar levels, thereby improving the interfacial stability between the first cathode active material layer 112 and the second cathode active material layer 114.

According to some embodiments, the second cathode active material layer 114 may have an electrode density of 2.0 g/cc to 2.5 g/cc. In some embodiments, the second cathode active material layer 114 may have an electrode density of 2.1 g/cc to 2.4 g/cc.

According to some embodiments, the cathode active material layer 110 may have an electrode density of 2.5 g/cc to 3.5 g/cc. In some embodiments, the cathode active material layer 110 may have an electrode density of 2.6 g/cc to 3 g/cc.

The electrode density of the cathode active material layer 110 may be calculated by dividing the total mass of the first cathode active material layer 112 and the second cathode active material layer 114 by the total volume of the first cathode active material layer 112 and the second cathode active material layer 114.

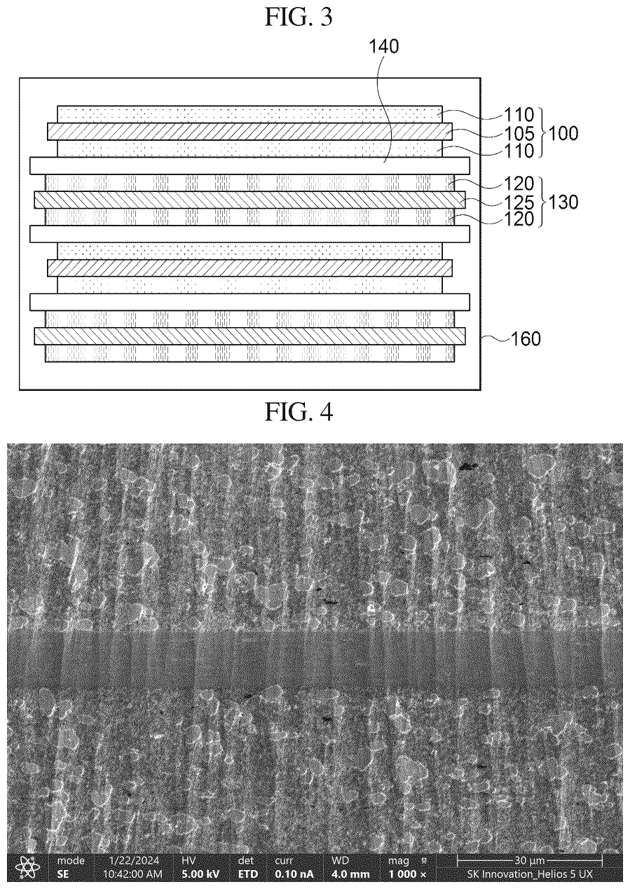

FIGS. 2 and 3 are schematic plan and cross-sectional views, respectively, illustrating a lithium secondary battery according to some embodiments. Specifically, FIG. 3 is a cross-sectional view taken along line I-I′ of FIG. 2 in the thickness direction of the lithium secondary battery.

Referring to FIGS. 2 and 3, a lithium secondary battery may include an electrode assembly 150 accommodated in a case 160. As shown in FIG. 3, the electrode assembly 150 may include the cathode 100, an anode 130 and a separation membrane 140 that are repeatedly stacked.

The cathode 100 may include the cathode active material layer 110 coated on the cathode current collector 105. Although not shown in detail in FIG. 3, the cathode active material layer 110 may include a stacked structure of the first cathode active material layer 112 and the second cathode active material layer 114, as described with reference to FIG. 1.

The anode 130 may include an anode current collector 125 and an anode active material layer 120 formed by coating the anode current collector 125 with an anode active material.

The anode active material may include a material capable of intercalating and deintercalating lithium ions. For example, carbon-based materials such as crystalline carbon, amorphous carbon, carbon composites, carbon fibers, etc.; a lithium alloy; silicon or tin may be used. Examples of the amorphous carbon may include hard carbon, coke, mesocarbon microbead (MCMB) calcined at 1500° C. or lower, mesophase pitch-based carbon fiber (MPCF) or the like. Examples of the crystalline carbon may include graphite-based carbon such as natural graphite, graphitized coke, graphitized MCMB, graphitized MPCF or the like. Other elements included in the lithium alloy may include, for example, aluminum, zinc, bismuth, cadmium, antimony, silicon, lead, tin, gallium, indium or the like.

The anode current collector 125 may include, for example, gold, stainless steel, nickel, aluminum, titanium, copper, or an alloy thereof, and preferably includes copper or a copper alloy.

In some embodiments, a slurry may be prepared by mixing the anode active material with a binder, a conductive material and/or a dispersant in a solvent, followed by stirring the mixture. The slurry may be coated on at least one surface of the anode current collector 125, followed by compression and drying to prepare the anode 130.

As the binder and the conductive material, materials which are substantially the same as or similar to the above-described materials used in the cathode active material layer 110 may be used. In some embodiments, a binder for forming an anode may include, for example, an aqueous binder such as styrene-butadiene rubber (SBR) to ensure compatibility with a carbon-based active material, and may be used together with a thickener such as carboxymethyl cellulose (CMC).

The separation membrane 140 may be interposed between the cathode 100 and the anode 130. The separation membrane 140 may include a porous polymer film made of a polyolefin polymer such as ethylene homopolymer, propylene homopolymer, ethylene/butene copolymer, ethylene/hexene copolymer, ethylene/methacrylate copolymer. The separation membrane 140 may include a nonwoven fabric made of glass fibers having a high melting point, polyethylene terephthalate fibers, etc.

In some embodiments, the anode 130 may have an area (e.g., a contact area with the separation membrane 140) and/or volume larger than those of the cathode 100. Thereby, lithium ions generated from the cathode 100 may may migrate smoothly to the anode 130 without being precipitated during the process, for example. Therefore, effects of simultaneously improving output and stability through a combination of the above-described first cathode active material layer 112 and the second cathode active material layer 114 may be more easily implemented.

According to exemplary embodiments, an electrode cell is defined by the cathode 100, the anode 130, and the separation membrane 140, and a plurality of electrode cells may be stacked to form, for example, a jelly roll type electrode assembly 150. For example, the electrode assembly 150 may be formed by winding, stacking, or folding the separation membrane 140.

The electrode assembly 150 may be accommodated in the case 160 together with an electrolyte to define the lithium secondary battery. According to exemplary embodiments, a non-aqueous electrolyte may be used as the electrolyte.

The non-aqueous electrolyte may include a lithium salt of an electrolyte and an organic solvent. The lithium salt is represented by, for example, Li⁺X⁻; and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)PF₄⁻, (CF₃)₃PF₃⁻, (CF₃)PF₂⁻, (CF₃)₅PF⁻, (CF₃)₆P⁻, CF₃SO₃⁻, CF₃CF₂SO₃⁻; (CF₃SO₂)₂N⁻, (FSO₂)₂N⁻, CF₃CF(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethylsulfuroxide, acetonitrile, dimethoxyethane, diethoxyethane, vinylene carbonate, sulfolane, gamma-butyrolactone, propylene sulfite and tetrahydrofuran, etc. may be used. These may be used alone or in combination of two or more thereof.

As shown in FIG. 2, electrode tabs (cathode tabs and anode tabs) protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) that extend or are exposed to an outside of the case 160.

FIG. 2 shows that the cathode lead 107 and the anode lead 127 protrude from an upper side of the case 160 in a planar direction, but positions of the electrode leads are not limited thereto. For example, the electrode leads may protrude from at least one of both sides of the case 160, or may protrude from a lower side of the case 160. Alternatively, the cathode lead 107 and the anode lead 127 may be formed so as to protrude from different sides of the case 160, respectively.

The lithium secondary battery may be manufactured, for example, in a cylindrical shape using a can, a prismatic shape, a pouch shape or a coin shape.

Hereinafter, embodiments of the present disclosure will be further described with reference to specific experimental examples. However, the examples and comparative examples included in the experimental examples are provided merely for illustrative purposes of the present disclosure and are not intended to limit the scope of the appended claims. It will be apparent to those skilled in the art that various changes and modifications can be made within the scope and spirit of the present disclosure, and such changes and modifications are to be regarded as falling within the scope of the appended claims.

### Example 1

### (1) Preparation of Cathode

LiNi_{0.6}Co_{0.1}Mn_{0.3}O₂ particles (D50: 3.6 μm) were mixed with carbon nanotubes as a conductive material, and polyvinylidene fluoride (PVDF) as a binder in a solvent at a weight ratio of 98.5:0.5:1 to prepare a first cathode slurry.

LiMn_{0.5}Fe_{0.5}PO₄ particles (D50: 0.87 μm) were mixed with carbon black as a particulate conductive material, carbon nanotubes as a fibrous conductive material, and polyvinylidene fluoride (PVDF) as a binder in a solvent at a weight ratio of 98:0.15:0.85:1 to prepare a second cathode slurry.

The first cathode slurry was applied to one surface of aluminum foil (thickness: 12 μm). The second cathode slurry was then applied onto the coated first cathode slurry layer, and then dried and roll-pressed to fabricate a cathode including a first cathode active material layer having a density of 3.6 g/cc and a thickness of 20 μm and a second cathode active material layer having a density of 2.4 g/cc and a thickness of 60 μm.

### (2) Manufacture of Lithium Secondary Battery

An anode slurry, which included 93 wt % of artificial graphite as an anode active material, 5 wt % of flake-type graphite (KS6) as a conductive material, 1 wt % of styrene-butadiene rubber (SBR) as a binder, and 1 wt % of carboxymethyl cellulose (CMC) as a thickener, was prepared. The anode slurry was coated onto a copper substrate, and then dried and roll-pressed to fabricate an anode.

The cathode and anode fabricated as described above were notched to a predetermined size and stacked, with a separator (polyethylene, thickness: 13 μm) interposed between the cathode and anode to form an electrode cell, and then the tab portions of the cathode and anode were welded, respectively. The assembly of the welded cathode/separator/anode was placed into a pouch, and three sides of the pouch were sealed, leaving one side open for electrolyte injection. At this time, a portion having the electrode tab was included in the sealing part. After injecting the electrolyte through the electrolyte injection side, the remaining electrolyte injection side was also sealed, followed by allowing it to be impregnated for 12 hours or more.

A solution, prepared by dissolving 1.2 M LiPF₆ in a mixed solvent of EC/EMC (25/75; volume ratio), and further adding 2 wt % vinylene carbonate (VC), 1 wt % fluoroethylene carbonate (FEC), and 0.3 wt % 1,3-propenesultone (PRS), was used as the electrolyte.

### Example 2

A cathode and battery were manufactured in the same manner as in Example 1, except that a second cathode active material layer having a density of 2.4 g/cc was formed using a second cathode slurry prepared by mixing LiMn_{0.6}Fe_{0.4}PO₄ particles (D50: 0.87 μm), carbon black as a particulate conductive material, carbon nanotubes as a fibrous conductive material, and polyvinylidene fluoride (PVDF) as a binder at a weight ratio of 98:0.2:0.8:1.

### Example 3

A cathode and battery were manufactured in the same manner as in Example 1, except that a second cathode active material layer having a density of 2.4 g/cc was formed using a second cathode slurry prepared by mixing LiMn_{0.6}Fe_{0.4}PO₄ particles (D50: 0.87 μm), carbon black as a particulate conductive material, carbon nanotubes as a fibrous conductive material, and polyvinylidene fluoride (PVDF) as a binder at a weight ratio of 98:0.25:0.75:1.

### Example 4

A cathode and battery were manufactured in the same manner as in Example 1, except that a second cathode active material layer having a density of 2.4 g/cc was formed using a second cathode slurry prepared by mixing LiMn_{0.6} Fe_{0.4}PO₄ particles (D50: 0.87 μm), carbon black as a particulate conductive material, carbon nanotubes as a fibrous conductive material, and polyvinylidene fluoride (PVDF) as a binder at a weight ratio of 98:0.3:0.7:1.

### Comparative Example 1

A cathode and battery were manufactured in the same manner as in Example 1, except that a second cathode active material layer having a density of 2.35 g/cc was formed using a second cathode slurry prepared by mixing LiMn_{0.6}Fe_{0.4}PO₄ particles (D50: 0.87 μm), carbon black as a particulate conductive material, carbon nanotubes as a fibrous conductive material, and polyvinylidene fluoride (PVDF) as a binder at a weight ratio of 97.88:0.4:0.72:1.

### Comparative Example 2

A cathode and battery were manufactured in the same manner as in Example 1, except that a second cathode active material layer having a density of 2.2 g/cc was formed using a second cathode slurry prepared by mixing LiMn_{0.6}Fe_{0.4}PO₄ particles (D50: 0.87 μm), carbon black as a particulate conductive material, carbon nanotubes as a fibrous conductive material, and polyvinylidene fluoride (PVDF) as a binder at a weight ratio of 97.48:0.8:0.72:1.

### Comparative Example 3

A cathode and battery were manufactured in the same manner as in Example 1, except that a second cathode active material layer having a density of 2.15 g/cc was formed using a second cathode slurry prepared by mixing LiMn_{0.6}Fe_{0.4}PO₄ particles (D50: 0.87 μm), carbon black as a particulate conductive material, carbon nanotubes as a fibrous conductive material, and polyvinylidene fluoride (PVDF) as a binder at a weight ratio of 97.28:1:0.72:1.

### Comparative Example 4

A cathode and battery were manufactured in the same manner as in Example 1, except that a second cathode active material layer having a density of 2.3 g/cc was formed using a second cathode slurry prepared by mixing LiMn_{0.6}Fe_{0.4}PO₄ particles (D50: 0.87 μm), carbon black as a particulate conductive material, carbon nanotubes as a fibrous conductive material, and polyvinylidene fluoride (PVDF) as a binder at a weight ratio of 97.28:0.2:1.52:1.

### Comparative Example 5

A cathode and battery were manufactured in the same manner as in Example 1, except that a second cathode active material layer having a density of 2.4 g/cc was formed using a second cathode slurry prepared by mixing LiMn_{0.6}Fe_{0.4}PO₄ particles (D50: 0.87 μm), carbon nanotubes as a fibrous conductive material, and polyvinylidene fluoride (PVDF) as a binder at a weight ratio of 98.28:0.72:1.

### Comparative Example 6

A cathode and battery were manufactured in the same manner as in Example 1, except that a second cathode active material layer having a density of 2.23 g/cc was formed using a second cathode slurry prepared by mixing LiMn_{0.6}Fe_{0.4}PO₄ particles (D50: 0.87 μm), carbon black as a particulate conductive material, and polyvinylidene fluoride (PVDF) as a binder at a weight ratio of 98.28:0.72:1.

### Comparative Example 7

LiMn_{0.6}Fe_{0.4}PO₄ particles (D50: 0.87 μm) and LiNi_{0.6}Co_{0.1}Mn_{0.3}O₂ particles (D50: 3.6 μm) were mixed and used as cathode active materials at a weight ratio of 7:3 and mixed with carbon nanotubes as a conductive material, and polyvinylidene fluoride (PVDF) as a binder in a solvent at a weight ratio of 98.5:0.5:1 to prepare a cathode slurry.

The cathode slurry was applied to one surface of aluminum foil (thickness: 12 μm), and then dried and roll-pressed to form a cathode active material layer having a density of 2.86 g/cc and a thickness of 71 μm, thereby fabricating a cathode. A battery was manufactured in the same manner as in Example 1, except that the cathode was used.

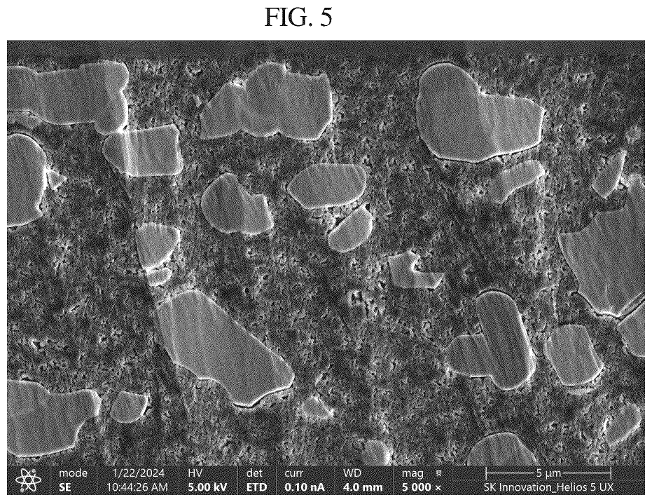

FIGS. 4 and 5 are scanning electron microscope (SEM) images showing the cross-section of the cathode of Comparative Example 7 at 1,000× and 5,000×, respectively.

Referring to FIGS. 4 and 5, the cathode active material layer of Comparative Example 7 was observed to be in a mixed form, including lithium transition metal oxide particles observed over a relatively large area and lithium metal phosphate particles observed over a relatively small area.

TABLE 1

| | | | | Electrode density (g/cc) | |
|---|---|---|---|---|---|
| | Content in the second cathode | | | Second | Total |
| | active material layer (wt %) | | | cathode | cathode |
| | Particulate | Fibrous | | active | active |
| | conductive | conductive | Content | material | material |
| | material | material | ratio | layer | layer |
| Example 1 | 0.15 | 0.85 | 5.67 | 2.4 | 2.7 |
| Example 2 | 0.2 | 0.8 | 4 | | |
| Example 3 | 0.25 | 0.75 | 3 | | |
| Example 4 | 0.3 | 0.7 | 2.33 | | |
| Comparative | 0.4 | 0.72 | 1.8 | 2.35 | 2.66 |
| Example 1 | | | | | |
| Comparative | 0.8 | 0.72 | 0.9 | 2.2 | 2.55 |
| Example 2 | | | | | |
| Comparative | 1 | 0.72 | 0.72 | 2.15 | 2.48 |
| Example 3 | | | | | |
| Comparative | 0.2 | 1.52 | 7.6 | 2.3 | 2.62 |
| Example 4 | | | | | |
| Comparative | — | 0.72 | — | 2.4 | 2.70 |
| Example 5 | | | | | |
| Comparative | 0.72 | — | — | 2.23 | 2.55 |
| Example 6 | | | | | |
| Comparative | Fault formation | | | — | 2.88 |
| Example 7 | | | | | |

$${}^{*} Electrode density of the total cathode active material layer = ( Density of first cathode active material layer \times Thickness of first cathode active material layer ) + ( Density of second cathode active material layer \times Thickness of second cathode active material layer ) / ( Thickness of first cathode active material layer + Thickness of second cathode active material layer )$$

### Experimental Example 1: Evaluation of Battery Internal Resistance

For the secondary batteries manufactured in the examples and comparative examples, charging and discharging were performed at each corresponding C-rate for 10 seconds, while the C-rate was sequentially varied to 0.2C, 0.5C, 1.0C, 1.5C, 2.0C, 2.5C and 3.0C at a 50% state-of-charge (SOC) point. The terminal voltage points at each C-rate were plotted to construct a linear equation, and the slope of the resulting line was adopted as the DC internal resistance (DCIR). The results are shown in Table 2 below.

### Experimental Example 2: Evaluation of High-Temperature Capacity Retention

Charging (CC-CV 0.5C 4.3V 0.05C cut-off) and discharging (CC 1.0C 2.5V cut-off) were repeated on the lithium secondary batteries of the above-described examples and comparative examples 100 times in a chamber maintained at 45° C. Then, the discharge capacity at 100th cycle was divided by the discharge capacity at the first cycle and multiplied by 100 to evaluate the capacity retention. The results are shown in Table 2 below.

### Experimental Example 3: Evaluation of Fast Charge Capacity Retention

Charging (20 minutes, CC charge multi-steps, SOC 10-80%) and discharging (CC 0.5C 2.5V cut-off) were repeated on the lithium secondary batteries of the above-described examples and comparative examples 100 times in a chamber maintained at 25° C. Then, the discharge capacity at 100th cycle was divided by the discharge capacity at the first cycle and multiplied by 100 to evaluate the fast charge capacity retention. The results are shown in Table 2 below.

TABLE 2

| | | | Fast-charge |
|---|---|---|---|
| | | High-temperature | capacity |
| | Battery | capacity | retention |
| | internal | retention | (25° C., 20 |
| | resistance | (45° C.) | minutes) |
| | (mΩ) | (%) | (%) |
| Example 1 | 2.0 | ≥98.0 | ≥99.0 |
| Example 2 | 2.0 | | |
| Example 3 | 2.0 | | |
| Example 4 | 2.0 | | |
| Comparative | 2.1 | ≤98.0 | ≤99.0 |
| Example 1 | | | |
| Comparative | 2.1 | ≤96.0 | |
| Example 2 | | | |
| Comparative | 2.1 | | |
| Example 3 | | | |
| Comparative | 2.0 | ≤95.0 | ≥99.0 |
| Example 4 | | | |
| Comparative | 2.35 | ≤98.0 | ≤96.0 |
| Example 5 | | | |
| Comparative | 2.35 | ≤96.0 | |
| Example 6 | | | |
| Comparative | 5.5 | ≤94.0 | ≤94.0 |
| Example 7 | | | |

Referring to Table 1, in the cathodes included in the batteries of the examples, the ratio of the content of the fibrous conductive material to the particulate conductive material content, based on the total weight of the second cathode active material layer, was 2 to 7. Accordingly, the batteries of the examples exhibited low internal resistance and improved high-temperature operational stability. On the other hand, in the cathodes included in the batteries of Comparative Examples 1 to 3, the ratio of the content of the fibrous conductive material to the particulate conductive material content, based on the total weight of the second cathode active material layer, was less than 2. Consequently, the internal resistance of the battery increased.

In the cathode included in the battery of Comparative Example 4, the ratio of the content of the fibrous conductive material to the particulate conductive material content, based on the total weight of the second cathode active material layer, was greater than 7. Consequently, the high-temperature capacity retention of the battery of Comparative Example 4 decreased.

In the cathodes included in the batteries of Comparative Examples 5 and 6, the second cathode active material layer contained only one type of conductive material. Consequently, the conductivity of the electrode decreased, resulting in an increase in the internal resistance of the battery.

The contents described above are merely examples of applying the principles of the present disclosure, and other configurations may be further included without departing from the scope of the present disclosure.

### DESCRIPTION OF REFERENCE NUMERALS

100: Cathode
105: Cathode current collector
110: Cathode active material layer
112: First cathode active material layer
114: Second cathode active material layer
120: Anode active material layer
125: Anode current collector
130: Anode
140: Separation membrane
150: Electrode assembly
160: Case

What is claimed is:

1. A cathode for a secondary battery comprising:
a cathode current collector, and
a first cathode active material layer and a second cathode active material layer sequentially stacked on at least one surface of the cathode current collector,
wherein the first cathode active material layer comprises lithium transition metal oxide particles,
wherein the second cathode active material layer comprises lithium metal phosphate particles, a particulate conductive material and a fibrous conductive material, and
wherein the ratio of the fibrous conductive material to the particulate conductive material, based on the total weight of the second cathode active material layer, is 2 to 7.

2. The cathode for a secondary battery according to claim 1, wherein the ratio of the fibrous conductive material to the particulate conductive material, based on the total weight of the second cathode active material layer, is 2.5 to 5.

3. The cathode for a secondary battery according to claim 1, wherein the ratio of the fibrous conductive material to the particulate conductive material, based on the total weight of the second cathode active material layer, is 2.33 to 5.67.

4. The cathode for a secondary battery according to claim 1, wherein the particulate conductive material comprises at least one selected from the group consisting of carbon black, graphite, graphene, tin, tin oxide, titanium oxide, LaSrCoO₃ and LaSrMnO₃.

5. The cathode for a secondary battery according to claim 1, wherein the fibrous conductive material comprises at least one selected from the group consisting of carbon nanotubes (CNTs), vapor-grown carbon fibers (VGCFs) and carbon nanofibers (CNFs).

6. The cathode for a secondary battery according to claim 1, wherein the content of the particulate conductive material, based on the total weight of the second cathode active material layer, is greater than 0 and less than or equal to 0.4% by weight.

7. The cathode for a secondary battery according to claim 1, wherein the content of the particulate conductive material, based on the total weight of the second cathode active material layer, is 0.15 to 0.3% by weight.

8. The cathode for a secondary battery according to claim 1, wherein the content of the fibrous conductive material, based on the total weight of the second cathode active material layer, is greater than 0 and less than or equal to 1% by weight.

9. The cathode for a secondary battery according to claim 1, wherein the content of the fibrous conductive material, based on the total weight of the second cathode active material layer, is 0.7 to 0.85% by weight.

10. The cathode for a secondary battery according to claim 1, wherein the lithium transition metal oxide particles include a crystal structure represented by Formula 1 below:
LiₐNi_{1-b}M2_{b}O_{c} [Formula 1]
(in Formula 1, 0<a≤1.2, 0<b<1, 2≤c≤2.02, and M2 comprises at least one selected from the group consisting of Co, Mn, Na, Mg, Ca, Ti, V, Cr, Cu, Zn, Ge, Sr, Ag, Ba, Zr, Nb, Mo, Al, Ga and B).

11. The cathode for a secondary battery according to claim 1, wherein the lithium transition metal oxide particles have a median particle diameter (D50) of 2 μm to 20 μm.

12. The cathode for a secondary battery according to claim 1, wherein the lithium metal phosphate particles comprises manganese.

13. The cathode for a secondary battery according to claim 1, wherein the lithium metal phosphate particles have a crystal structure represented by Formula 2 below:
LiMnₓFe₁₋ₓM1_{y}PO₄ [Formula 2]
(in Formula 2, 0<x<1, 0≤y≤0.1, and M1 comprises at least one selected from the group consisting of Ni, Co, Na, Mg, Ca, Ti, V, Cr, Cu, Zn, Ge, Sr, Ag, Ba, Zr, Nb, Mo, Al, Ga and B).

14. The cathode for a secondary battery according to claim 13, wherein in Formula 2, x is in the range of 0.55≤x≤0.8.

15. The cathode for a secondary battery according to claim 1, wherein the lithium metal phosphate particles have a median particle diameter (D50) of 0.1 μm to 1.5 μm.

16. The cathode for a secondary battery according to claim 1, wherein the ratio of the thickness of the second cathode active material layer to the thickness of the first cathode active material layer is 1.5 to 4.

17. The cathode for a secondary battery according to claim 1, wherein the second cathode active material layer has an electrode density of 2.0 g/cc to 2.5 g/cc.

18. A lithium secondary battery comprising:
an anode; and
the cathode for a secondary battery according to claim 1 disposed to face the anode.
